(19) United States
(12) Patent Application Publication
(10) Pub. No.: US 2006/0174225 A1
(43) Pub. Date: Aug. 3, 2006

(54) Debugging a High Level Language Program Operating Through a Runtime Engine

(75) Inventors: Jonathan D. Bennett, Markham, Ontario (CA); Jane Chi-Yan Fung, Thornhill, Ontario (CA); Paul J. Gooderham, Markham, Ontario (CA); Grace H. Lo, Thornhill, Ontario (CA); William G. O'Farrell, Markham, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/906,050

(22) Filed: Feb. 1, 2005

(51) Int. Cl. G06F 9/44

(52) U.S. Cl. 717/124

(57) ABSTRACT

In a remote runtime engine, a method for debugging a remotely executing high level language specified computer program can include the steps of interpreting a high level language specified computer program and receiving debug messages from a debug tool over a computer communications network. Consequently, the received debug messages can be applied to the high level language specified computer program. Additionally, debug messages can be sent to the debug tool over the network. In a particular aspect of the invention, the method can include setting a breakpoint in the runtime engine on a method specifying logic for receiving the debug messages. Responsive to reaching of the breakpoint, the receiving and applying steps can be performed for a debug message in a message queue in the debug tool. Similarly, a breakpoint can be set in the remote runtime engine, and responsive to reaching the breakpoint, the sending step can be performed.

### BACKGROUND OF THE INVENTION

The present invention relates to debugging tools for computer programs, and more particularly to debugging high level language programs operating in concert with a remote runtime engine.

### DESCRIPTION OF THE RELATED ART

High level languages trace their origins far beyond the venerable BasicA of CP/M fame. Though compliable lower level languages ultimately came into vogue and dominated the computer science field for more than twenty years, interpretable high level languages have become popular once again due to the flexibility in defining program logic and interactions between different application components including remote components. Due to the nature of interpretable high level languages, higher level program development environments require the use of a runtime engine to process the logic of the underlying program. In this regard, a runtime engine can be required whether the underlying program logic has been included in source code, markup language or another persisted form.

Debugging simple, single platform, high level language specified programs can be indistinguishable from the process of debugging low level languages utilizing the same debugging tools for the interpreter as would be utilized in an integrated development environment for a low level language. Difficulties arise, however, where the higher level language supports remote computing. In particular, some high level languages including well-known flow languages like the Business Process Execution Language (BPEL) for Web Services, specifically support and often require the logical distribution of computing components in a vast network environment.

In the case of a distributed application defined according to the logic of a high level language, one or more remotely positioned runtime engines can be configured to interpret and execute the logic of the high level language. During the development of the distributed application, however, it is not reasonable to expect that the developer can access both debugging tools and the runtime engine in the same computing platform. Rather, it is to be expected that the development and debugging environment remains separate and remote from the runtime engine. Accordingly, the most fundamental utilities in a debugging environment including breakpoints, variable value watching, modification and inspection, and program state monitoring cannot be easily applied when debugging aspects of a high level language specified program.

Notwithstanding, some high level language runtime engines have incorporated debugging logic within the engine. Thus, when debugging an interpretable high level language like BPEL for Web Services, it is necessary to communicate with the runtime engine in order to command the operation of whatever debugging functions may be provided by the runtime engine. At present, it is known only to utilize sockets or an auxiliary independent communications channel to facilitate debugging communications between a debugging tool and a runtime engine for interpretable high level languages. Yet, auxiliary channels of communication are known to be unreliable and can require setup and configuration beyond what is considered acceptable for debugging.

Lower level languages able to handle distributed computing such as the JAVA™ programming language can enjoy remote debugging capabilities by way of the JAVA Platform Debugger Architecture (JPDA). JDPA can include a modular structure disposed across a communications network between a debuggee and a debugger. The debuggee (typically a virtual machine) can be configured with a JAVA virtual machine debug interface (JVMDI). The remote debugger, by comparison, can be configured with a JAVA debug interface (JDI). The JVMDI and the JDI can communicate utilizing a communications channel defined by the JAVA debug wire protocol (JDWP). The transport mechanism for JVMDI can range from sockets, to serial lines to shared memory. Despite the advanced capabilities of JDPA, no similar architecture exists for interpretable high level languages including BPEL for Web Services.

### SUMMARY OF THE INVENTION

The present invention addresses the deficiencies of the art in respect to remote debugging and provides a novel and non-obvious method, system and apparatus for debugging high level language programs operating through run time engines, A system implementation of the invention can include a runtime engine configured to interpret high level language specified computer programs and a debugging tool configured to execute remotely from the runtime engine. The system further can include a remote debugging interface having debug management logic and coupled to the runtime engine. Finally, a client debugging interface can be coupled to the debugging tool and configured to communicate with the remote debugging interface.

In a specific aspect of the invention, the remote debugging interface and the client debugging interface can have programming to communicate with each other utilizing a debug wire protocol. Moreover, the runtime engine can be a BPEL runtime engine. More particularly, the runtime engine can be a JAVA coded BPEL runtime engine configured for operation in a virtual machine. In that case, the remote debugging interface can be JVMDI, the client debugging interface can be JDI, and the JVMDI and JDI can communicate utilizing a communications channel defined by JDWP.

In a remote runtime engine, a method for debugging a remotely executing high level language specified computer program can include the steps of interpreting a high level language specified computer program and receiving debug messages from a debug tool over a computer communications network. Consequently, the received debug messages can be applied to the high level language specified computer program. Additionally, debug messages can be sent to the debug tool over the computer communications network. The content of the messages may be unaltered from that transmitted from the debug tool.

In a particular aspect of the invention, the method can include setting a breakpoint in the remote runtime engine on a method specifying logic for receiving the debug messages. Responsive to reaching of the breakpoint, the receiving and applying steps can be performed for a debug message in a message queue in the debug tool. Similarly, a breakpoint can be set in the remote runtime engine, and responsive to reaching the breakpoint, the sending step can be performed.

Finally, an additional breakpoint can be set on a method in the remote runtime engine defined to execute when ending a debugging session in the remote runtime engine. Subsequently, the additional breakpoint can be removed when ending the debugging session to allow the method to message the remote runtime engine that the debugging session has ended. To address the inadvertent resumption of the additional breakpoint, a counter can be incremented in the method whenever the additional breakpoint is resumed. As such, the remote runtime engine can be messaged that the debugging session has ended only if the counter exceeds a threshold value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a debugging system for debugging a high level language program operating in concert with a remote runtime engine;

FIG. 2 is a block diagram illustrating a debugging process for use in the system of FIG. 1; and,

FIG. 3A and FIG. 3B, taken together, are timing diagrams illustrating processes for message exchanges between the remote runtime engine and debugger of the system of FIG. 1.

### DETAILED DESCRIPTION OF THE PREFERRED EMBODIMENTS

The present invention is a method, system and apparatus for debugging a high level language program operating through a remote runtime engine. In accordance with the present invention, a remote runtime engine can be coupled to remote debugging interface. The remote debugging interface can obtain program operation information from the runtime engine and the remote debugging interface can transmit the program operation information to a companion client debugging interface over a computer communications network. Conversely, the companion client debugging interface can pass debugging commands over the computer communications network to the remote debugging interface. The remote debugging interface, in turn, can pass the messages to the remote runtime engine for application to the high level language program.

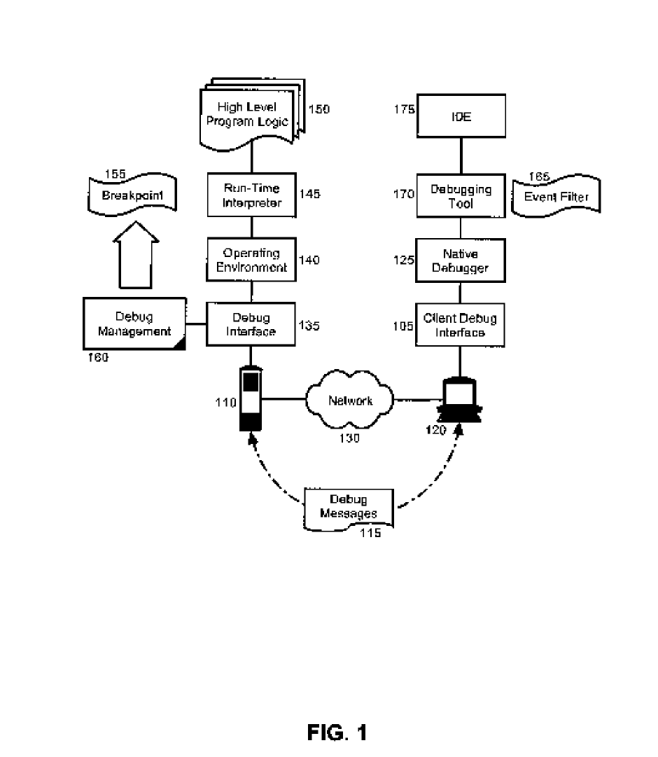

In a more particular illustration, FIG. 1 is a schematic illustration of a debugging system for debugging a high level language program operating in concert with a remote runtime engine. Specifically, a client computing platform 120 can be communicatively linked to a server computing platform 110 over a computer communications network 130. The client computing platform 120 can host an integrated development environment 175. The server computing platform 110 can include at least one operating environment 140 for hosting a runtime engine 145. In this regard, to the extent that the operating environment 140 can interpret and process byte code programs, the operating environment can be a virtual machine such as a JAVA virtual machine, and the runtime engine 145 can be a byte-code implementation of a runtime engine.

The runtime engine 145 can process a computer program 150 specified utilizing a high level programming language requiring interpretation. For instance, the computer program 150 can be a flow language specified application having one or more markup language pages. In a particular aspect of the present invention, the computer program 150 can be a BPEL for Web Services specified application having one or more markup language documents formatted according to the BPEL for Web Services specification. In this way, the runtime engine 145 can parse the pages of the computer program 150 to manage the operation of the application defined by the computer program 150.

In accordance with the present invention, the operating environment 140 can be configured with a remote debugging interface 135. To the extent that the operating environment 140 is a virtual machine such as a JAVA virtual machine, the remote debugging interface can be a virtual machine debug interface such as that described in the JPDA architecture. The remote debugging interface 135 can be communicatively linked to a client debug interface 105 coupled to a debugging tool 170 operating in association with a native debugger 125 such as a JDPA compliant debugger, and implemented as a plug-in to the integrated development environment 175 in the client computing platform 120. The communicative linkage established between the remote debugging interface 135 and the client debug interface 105 optionally can confirm to JDWP and can carry debug messages 115 between the debugging tool 170 by way of the native debugger 125, and the runtime engine 145.

To enable the interoperation of the runtime engine 145 with the debugging tool 170 through the operating environment 140, debug management logic 160 can be coupled to the remote debugging interface 135. The debug management logic 160 can manage the operation of the runtime engine 145 so that messages can be exchanged with the runtime engine 145 and the debugging tool 170 via the communications channel established between the client debugging interface 105 and the remote debugging interface 135.

Specifically, the debug management logic 160 can utilize operating environment 140 supported breakpoints and variable access and modification facilities to control the runtime engine 145. When communications are to occur between the debug management logic 160 and the debugging tool 170, the debug management logic 160 can make use of a breakpoint created by debugging tool 170 through native debugger 125 that stops the operation of the high level program logic 15 long enough to utilize variable modification to transfer a message into the runtime engine 145, or to utilize variable access to transfer a message out of the runtime engine 145. Once the message has been transferred, the operation of the high level program logic 150 can be resumed.

The messages transferred into the runtime engine 145 and out from the runtime engine 145 can include commands and status reports, such as those which are ordinarily exchanged between a debugging tool and a program under the control of a debugging tool. For example, inbound messages can include commands to run a computer program specified by the high level program logic, or to set a variable in the computer program to a particular value. By comparison, outbound messages can include status reports from the runtime engine 145.

The debugging tool 170 and the native debugger 125 can be implemented as plug-ins to the integrated development environment 175 and the debugging tool 170 can start when the native debugger 125 connects to the operating environment 140. When the debugging tool 170 starts, the client debugging interface 105 can establish a communicative linkage with the remote debugging interface 135 and commands can be issued by the debugging tool 170 to set three hidden breakpoints 155.

The hidden breakpoints 155 can be characterized as either communications breakpoints or guard breakpoints. Notably, an event filter 165 can be included with the debugging tool 170 to filter the messages 115 to detect when the runtime engine 145 halts as a result of one of the communication breakpoints. When the runtime engine 145 halts as a result of one of the communications breakpoints, the debug management logic 160 can cause the run-time interpreter 145 to engage in message passing of debug messages with the debugging tool 170.

The communications breakpoints created in the runtime engine 145 can break on send message and receive message operations. Importantly, the communications breakpoints created in the runtime engine 145 can remain hidden from view of an end user of the debugging tool 170 and native debugger 125 by withholding the communications breakpoints from registration with the breakpoint manager of the native debugger 125 Additionally, a unique attribute can be associated with each communications breakpoint so that the communications breakpoint can be positively identified at a later time. Finally, the communications breakpoints need not be removed explicitly when the native debugger 125 disconnects from the operating environment 140 because the breakpoints are removed automatically by the underlying native debugger 125.

The communications breakpoints serve two purposes: First, the breakpoints suspend a thread in the runtime engine 145, and second, the breakpoints signal the debug management logic 160 that the time to transfer debug messages 115 has arrived. In the first circumstance, the thread is suspended because messages can be written from or to variables in the runtime engine 145 utilizing the remote debug interface 135. It is to be noted by the skilled artisan that in the circumstance that the remote debug interface 135 is a JAVA debug virtual machine interface compliant interface, a JAVA variable can be modified via a JAVA debug interface form of the client debug interface 105 by referencing a suspended thread as opposed to a non-suspended thread.

Unlike the communications breakpoints, a guard breakpoint can be a hidden breakpoint created for association with a method internal to the runtime engine which processes the end of a debugging session. The purpose of the guard breakpoint is to communicate to the runtime engine 145 when the debugging tool 170 has disconnected from the runtime engine 145. In operation, when the runtime engine 145 starts up and when a debugging session begins, a thread (not shown) can be created which can call the internal method which processes the end of the debugging session. The operation of the thread can stop immediately as the breakpoint is encountered.

When the breakpoint is removed as the debugging tool 170 disconnects from the runtime engine 145, the operation of the internal method can proceed. In particular, the internal method can send a message to the runtime engine 145 informing the runtime engine 145 that the debugging session has ended. To protect against the inadvertent resumption of the breakpoint before the debugging session has ended, a counter can be included in the internal method. The counter can be incremented whenever the breakpoint is resumed, but the debug session will not be considered complete unless the counter reaches a threshold value. Accordingly, so long as the breakpoint remains in place, one would be required to inadvertently resume the breakpoint beyond a threshold number of times in order to inadvertently end the debugging session, however, if the breakpoint is removed entirely, the threshold will be reached quickly.

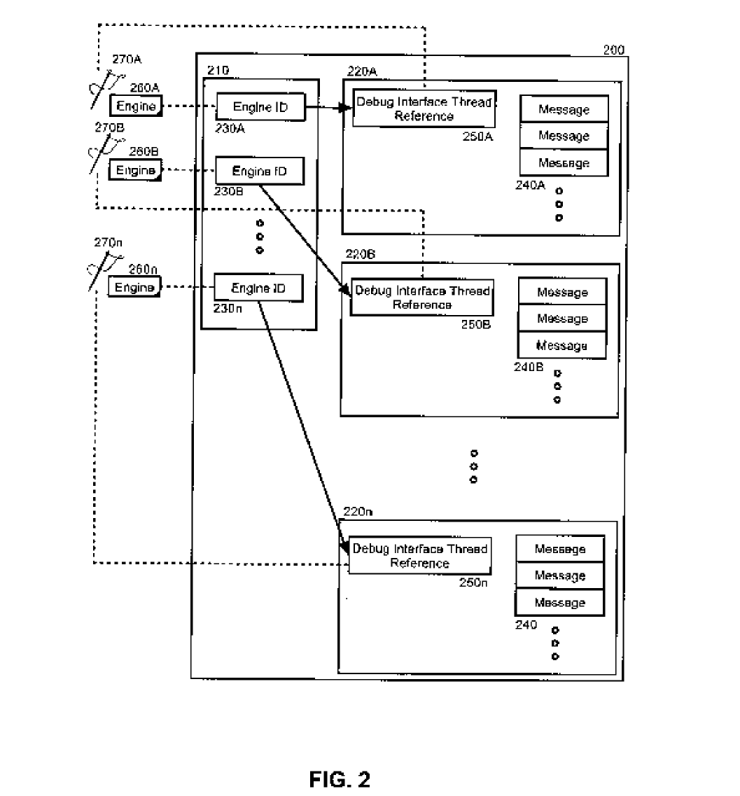

Referring now to FIG. 2, a block diagram is shown which illustrates a debugging process for use in the system of FIG. 1. Since it is possible for the debugging tool 200 to be communicatively linked to multiple, different runtime engines 260A, 260B, 260n in one or more computing platforms at any one time, the debugging tool 200 can create a separate reference 230A, 230B, 230n and corresponding queue 220A, 220B, 220n for each of the runtime engines 260A, 260B, 260n . In particular, each of the references 230A, 230B, 230n can be a unique identifier for use by the debug tool 200 when associating messages 240A, 240B, 240n with corresponding queues 220A, 220B, 220n.

Locally, the debugging tool 200 can create a thread notation 250A, 250B, 250n to track corresponding threads 270A, 270B, 270n on the remote system dedicated to receiving debugger messages 240A, 240B, 240n . Only a single thread reference 250A, 250B, 250n need be allocated per runtime engine 260A, 260B, 260n in order to ensure that messages 240A, 240B, 240n are sent to the runtime engine 260A, 260B, 260n in the same order as they are generated in the debugging tool 200. The debugging tool 200 can place the messages 240A, 240B, 240n in a corresponding queue 220A, 220B, 220n holding the messages 240A, 240B, 240n destined for the corresponding runtime engine 260A, 260B, 260n associated with a respective reference 230A, 230B, 230n.

Remotely, threads 270A, 270B, 270n can be created to wait for messages from the debugging tool 200. The threads 270A, 270B, 270n can call a receive message method when a breakpoint is encountered in the runtime engine 260A, 260B, 260n . The receive message method can cause the runtime engine 260A, 260B, 260n to receive a message 240A, 240B, 240n from a corresponding one of the queues 220A, 220B, 220n . Subsequently, the received message 240A, 240B, 240n can be processed in the thread 270A, 270B, 270n and the receive message method can be called once again. Additionally, to the extent that a message 240A, 240B, 240n requires a response, the thread 270A, 270B, 270n can call a send message method to transfer a response to the debugging tool 200.

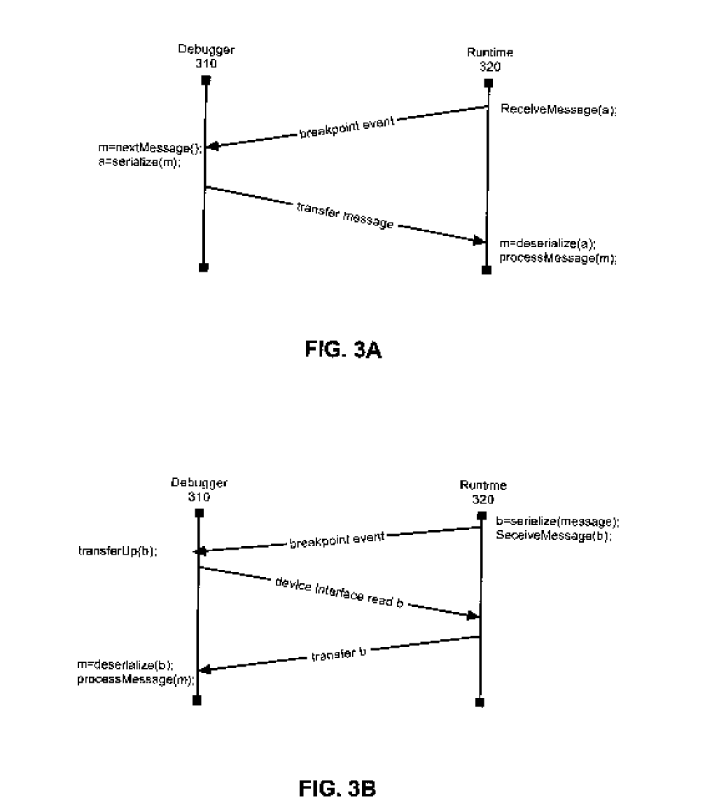

FIG. 3A and FIG. 3B, taken together, are timing diagrams illustrating processes for message exchanges between the remote runtime engine and debugger of the system of FIG. 1. Referring first to FIG. 3A, when a thread in the runtime engine 320 calls a receive message method, the communications breakpoint set for the receive message method will be reached and a breakpoint suspend event will be generated in the debug tool 310. The debug tool 310 can be registered as an event listener and when the suspend event associated with the breakpoint is detected, the debug tool 310 can check the queue of outgoing messages.

If a message is waiting, the message can be serialized and the bytes of the message can be transferred to the runtime engine 320 utilizing the debug interface for the debug tool. The received bytes can be formed into an array in the runtime engine 320 and the array can be assigned as a method argument to the receive message method. Subsequently, the breakpoint can be resumed and the receive message method can process the received message by de-serializing the message and handling the de-serialized message as a debugger message.

Notably, the original breakpoint suspend event triggered on entry to the receive message method in the runtime engine 320 can be filtered out of the event stream of the debug tool 310 so that the breakpoint suspend event is not reported to the user interface of the debug tool 310. Similarly, any event triggered through the resumption of the breakpoint will be filtered out. In any event, when the breakpoint event is received, if no messages remain in the queue to be transmitted, the thread can be permitted to remain suspended at the breakpoint until a message is inserted in the queue. As the thread is dedicated to the communication between the runtime engine 320 and the debug tool 310, the prolonged suspension of the thread will be of no consequence.

Referring now to FIG. 3B, when a thread in the runtime engine 320 calls the send message method, the hidden breakpoint can be encountered and a breakpoint suspend event can be generated. Once again, the event filter can detect the breakpoint suspend event and the message can be read from the argument of the send message method using the debug interface to the debug tool 310. Subsequently, the suspended thread in the runtime engine 320 can be resumed after the message is transferred to the debug tool 310 and de-serialized for processing.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A debugging system for high level language programs operating through run time engines, the system comprising:
a runtime engine configured to interpret high level language specified computer programs;
a debugging tool configured to execute remotely from said runtime engine;
a remote debugging interface having debug management logic and coupled to said runtime engine; and,
a client debugging interface coupled to said debugging tool and configured to communicate with said remote debugging interface.

2. The system of claim 1, wherein said remote debugging interface and said client debugging interface have programming to communicate with each other utilizing a debug wire protocol.

3. The system of claim 1, wherein said runtime engine is a business process execution language (BPEL) runtime engine.

4. The system of claim 1, wherein said runtime engine is a JAVA coded business process execution language (BPEL) runtime engine configured for operation in a virtual machine.

5. The system of claim 4, wherein said remote debugging interface is a JAVA virtual machine debug interface (JVMDI), wherein said client debugging interface is a JAVA debug interface (JDI), and wherein said JVMDI and JDI communicate utilizing a communications channel defined by JAVA debug wire protocol (JDWP).

6. In a remote runtime engine, a method for debugging a remotely executing high level language specified computer program comprising the steps of:
interpreting a high level language specified computer program;
receiving debug messages from a debug tool over a computer communications network; and,
applying said received debug messages to said high level language specified computer program.

7. The method of claim 6, further comprising the step of sending debug messages to said debug tool over said computer communications network.

8. The method of claim 6, further comprising the steps of:
setting a breakpoint in the remote runtime engine on a method specifying logic for receiving said debug messages; and,
responsive to reaching of said breakpoint, performing said receiving and applying steps for a debug message in a message queue in said debug tool.

9. The method of claim 7, further comprising the steps of:
setting a breakpoint in the remote runtime engine; and,
responsive to reaching said breakpoint, performing said sending step.

10. The method of claim 8, further comprising the steps of:
setting an additional breakpoint on a method in the remote runtime engine defined to execute when ending a debugging session in the remote runtime engine; and,
removing said additional breakpoint when ending said debugging session to allow said method to message the remote runtime engine that said debugging session has ended.

11. The method of claim 10, further comprising the steps of:
incrementing a counter in said method whenever said additional breakpoint is resumed; and,
messaging the remote runtime engine that said debugging session has ended only if said counter exceeds a threshold value.

12. The method of claim 8, further comprising the step of filtering said breakpoint out of an event stream for said debug tool.

13. The method of claim 8, further comprising the step of responsive to starting the remote runtime engine, spawning a thread in the remote runtime engine, said thread having logic to call said method specifying logic for receiving said debug messages.

14. A machine readable storage having stored thereon a computer program, the computer program comprising a routine set of instructions which when executed by a machine causes the machine to perform the steps of:
interpreting a high level language specified computer program;
receiving debug messages from a debug tool over a computer communications network; and,
applying said received debug messages to said high level language specified computer program.

15. The machine readable storage of claim 14, further comprising additional instructions for causing the machine to further perform the step of sending debug messages to said debug tool over said computer communications network.

16. The machine readable storage of claim 14, further comprising additional instructions for causing the machine to further perform the steps of:
setting a breakpoint in a remote runtime engine on a method specifying logic for receiving said debug messages; and,
responsive to reaching of said breakpoint, performing said receiving and applying steps for a debug message in a message queue in said debug tool.

17. The machine readable storage of claim 14, further comprising additional instructions for causing the machine to further perform the steps of:
setting a breakpoint in a remote runtime engine; and,
responsive to reaching said breakpoint, performing said sending step.

18. The machine readable storage of claim 16, further comprising additional instructions for causing the machine to further perform the steps of:
setting an additional breakpoint on a method in a remote runtime engine defined to execute when ending a debugging session in said remote runtime engine; and,
removing said additional breakpoint when ending said debugging session to allow said method to message said remote runtime engine that said debugging session has ended.

19. The machine readable storage of claim 18, further comprising additional instructions for causing the machine to further perform the steps of:
incrementing a counter in said method whenever said additional breakpoint is resumed; and,
messaging a remote runtime engine that said debugging session has ended only if said counter exceeds a threshold value.

20. The machine readable storage of claim 16, further comprising additional instructions for causing the machine to further perform the step of filtering said breakpoint out of an event stream for said debug tool.

21. The machine readable storage of claim 16, further comprising additional instructions for causing the machine to further perform the step of responsive to starting the remote runtime engine, spawning a thread in the remote runtime engine, said thread having logic to call said method specifying logic for receiving said debug messages.
